(19) United States
(12) Patent Application Publication
(10) Pub. No.: US 2026/0277545 A1
(43) Pub. Date: Sep. 17, 2026

(54) HARDWARE CIRCUIT FOR STATISTICAL REDUCTION DURING DATA TRANSPORT

(71) Applicant: NVIDIA Corporation, Santa Clara, CA (US)

(72) Inventors: Maciej Tyrlik, Durham, NC (US); Ajay Sudarshan Tirumala, San Jose, CA (US); Manan Patel, San Jose, CA (US); Shirish Gadre, Fremont, CA (US); Ming Yiu Siu, Sammamish, WA (US)

(21) Appl. No.: 19/445,070

(22) Filed: Jan. 9, 2026

Related U.S. Application Data
(60) Provisional application No. 63/772,225, filed on Mar. 14, 2025.

(51) Int. Cl. G06F 7/523; G06F 7/50

(52) U.S. Cl. CPC G06F 7/523; G06F 7/50

(57) ABSTRACT

Apparatuses, systems, and techniques for performing statistical calculations during data transport in graphics processing units are disclosed herein. The system may include a statistical reduction circuit coupled to a data transport circuit. The statistical reduction circuit performs statistical reduction operations on data elements during transfer from tensor memory or directly from matrix multiply-accumulate arrays to register files. The statistical reduction circuit may compute running statistical values as each data element is transferred, eliminating separate computational passes. The system may include not-a-number handling circuitry that implements filtering modes for wide reduction operations. The system may support statistical operations such as determination of a maximum value, a minimum value, and absolute value variants, while processing multiple numeric formats. The integrated statistical computation capability can reduce latencies and eliminate register file bandwidth conflicts during statistical processing through concurrent data movement and statistical computation.

### RELATED APPLICATION

This non-provisional application claims priority to U.S. Patent Application No. 63/772,225, filed Mar. 14, 2025, entitled “STATISTICS CALCULATION DURING DATA TRANSPORT,” which is incorporated herein by reference in its entirety for all purposes.

### TECHNICAL FIELD

At least one embodiment pertains to techniques for efficient reduction operations in parallel processors through hardware circuitry that combines data movement with concurrent computational operations.

### BACKGROUND

Graphics processing unit architectures have evolved to support increasingly complex computational workloads, particularly in artificial intelligence and machine learning applications. Modern transformer-based workloads require extensive statistical operations on tensor data, creating computational bottlenecks that exceed the capabilities of current data processing approaches. High-throughput matrix multiply-accumulate units produce results at rates that exceed register file bandwidth capacity. This has necessitated the use of intermediate tensor memory hierarchies. These hierarchies store computation results before transferring them to register files for further processing.

### BRIEF DESCRIPTION OF THE DRAWINGS

FIG. 1 is a block diagram of a system for statistical calculations during data transport, according to at least one embodiment;

FIG. 2 is a block diagram showing example components of a data transport path, according to at least one embodiment;

FIG. 3A illustrates example components of a statistical reduction circuit including Not-a-Number (NaN) handling capabilities, according to at least one embodiment;

FIG. 3B illustrates an example data format handling circuit for supporting multiple numeric formats, according to at least one embodiment;

FIG. 3C illustrates an alternative embodiment of a statistical reduction circuit including an accumulator circuit for sum operations, according to at least one embodiment;

FIG. 4 illustrates example components of a NaN handling circuit for specialized floating-point processing, according to at least one embodiment;

FIG. 5 illustrates a flow diagram of a method for performing statistical calculations during data transport, according to at least one embodiment; and

FIG. 6 shows a flow diagram of an example process for concurrent data movement and statistical processing, according to at least one embodiment.

### DETAILED DESCRIPTION

Graphics processing unit (GPU) architectures commonly encounter computational bottlenecks that surpass the capabilities of existing data processing methodologies, particularly when executing transformer-based workloads that necessitate statistical operations on tensor data. The advent of high-throughput matrix multiply-accumulate (MMA) units, which generate results at rates exceeding conventional register file bandwidth capacity, has driven the implementation of intermediate tensor memory hierarchies. These hierarchies are designed to store computation results prior to their transfer to register files for subsequent processing. However, this architectural evolution has introduced performance limitations. For instance, statistical operations such as softmax calculations can consume 192 cycles for 128-column operations, including 64 cycles for data loading and an additional 128 cycles for statistical computation. Such latencies can significantly degrade overall system performance.

GPU systems typically employ one of two primary approaches for handling statistical computations on tensor data. The first approach involves loading all tensor data from intermediate memory into register files, followed by the execution of separate statistical reduction operations using dedicated arithmetic units. Systems utilizing this sequential data loading and computation suffer from register file bandwidth saturation, which prevents efficient overlapping of operations. Register files operating at capacity during tensor operations cannot accommodate the additional read and write operations required for statistical processing without performance degradation. The second approach involves pipelining the data loading operations with statistical computations by utilizing additional register file bandwidth and computational resources across parallel execution streams. However, pipelined execution necessitates multiple register file ports, which would mandate multi-bank register file implementations, resulting in substantial increases in both area and power consumption.

These inherent limitations are particularly pronounced in transformer workloads where small hidden dimensions expose statistical computation latencies that cannot be effectively concealed through matrix multiply-accumulate operation pipelining. Both existing approaches present significant limitations that preclude optimal performance in bandwidth-constrained tensor processing environments.

Aspects of the present disclosure address the challenges described above and others by providing systems and techniques that integrate statistical reduction operations directly within data transport circuits for graphics processing unit tensor memory architectures. Unlike systems that perform data loading and statistical computation as distinct, sequential operations, the disclosed system may combine both functions within a single instruction execution cycle based on concurrent data path processing.

In some embodiments, a graphics processing unit circuit may include a tensor memory configured to store matrix multiply-accumulate operation results, a register file configured to store data for arithmetic operations, and a data transport circuit coupled between the tensor memory and the register file, configured to transfer data elements while simultaneously performing statistical operations. In some embodiments, the data transport circuit may be configured to receive data elements from multiple sources during transfer operations. The data transport circuit may read data directly from matrix multiply-accumulate arrays during final computation iterations, bypassing intermediate storage in tensor memory for improved latency and reduced memory bandwidth utilization. Alternatively, the data transport circuit may read previously stored data from tensor memory for subsequent processing operations, providing flexible data sourcing based on computational workflow requirements.

In some embodiments, the integrated statistical reduction circuit may compute one or more running statistical values as each data element is transferred from the tensor memory to the register file, eliminating the need for separate computational passes over stored data. Furthermore, the data transport circuit may transfer multiple columns of data elements per cycle, while the statistical reduction circuit continuously updates the reduction operations during the transfer process. A control circuit may be configured to execute a single instruction that simultaneously activates both data movement and statistical computation functions.

To enhance reliability and flexibility, some embodiments may incorporate a conditional processing circuit capable of implementing specialized not-a-number (NaN) value handling for wide reduction operations, particularly where individual element inspection becomes impractical. The conditional processing circuit may select between filtering modes that either exclude not-a-number values from statistical operations (unless all elements within the operation contain not-a-number values), or output a not-a-number result when any input element contains a not-a-number value. This capability can effectively address scenarios where out-of-bounds data padding employs not-a-number values, which require different handling semantics than computational error conditions.

The integrated statistical computation capability can provide significant benefits, including a reduction in cycle counts (e.g., from 192 to 64 cycles for 128-column operations) and the elimination of register file bandwidth conflicts during statistical processing. The system may support a diverse range of statistical operations, such as determination of maximum value, minimum value, and absolute value variants. Additionally, the system can process multiple numeric formats, such as floating-point, unsigned integer, and signed integer data types. This concurrent processing capability can offer substantial cycle efficiency improvements while maintaining the simplicity of a single instruction programming model.

The disclosed techniques offer numerous advantages including, but not limited to, performance improvements through substantial cycle count reduction (e.g., from 192 to 64 cycles for typical 128-column tensor operations). Efficiency is improved by eliminating separate statistical computation passes that would otherwise require additional register file access cycles. Scalability is enhanced through register bandwidth optimization, thereby avoiding expensive multi-bank register file implementations. Reliability is improved via integrated not-a-number handling, which can ensure consistent behavior across wide reduction operations. The techniques provide flexibility via support for multiple statistical operation types and numeric data formats within a unified instruction architecture. Power consumption is reduced by eliminating redundant register file operations. Computational throughput is improved through concurrent data movement and statistical processing.

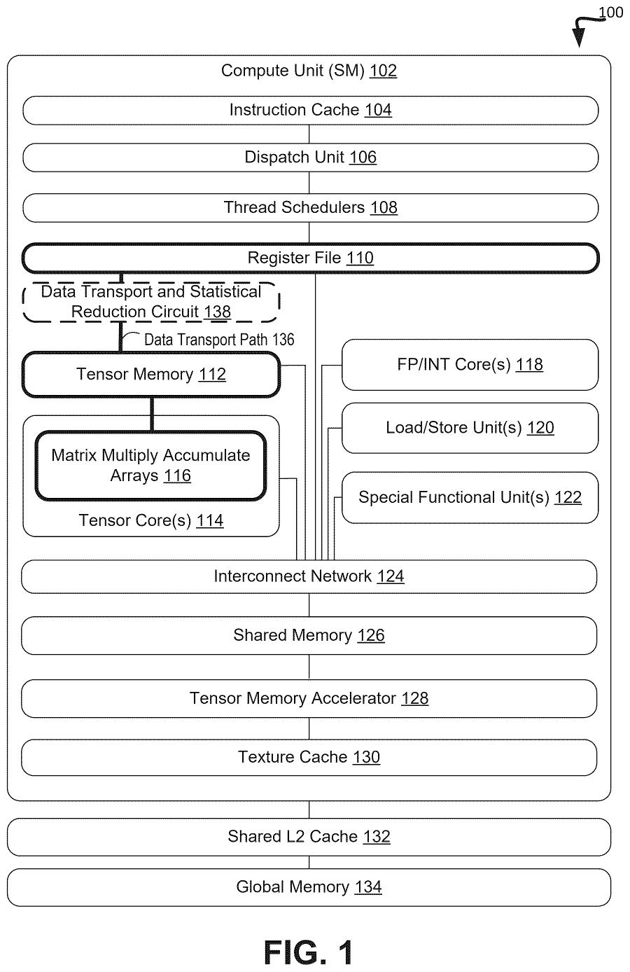

FIG. 1 is a block diagram of a system 100 for statistical calculations during data transport, according to at least one embodiment. An example of the system 100 is a graphics processing unit (GPU) that can execute multiple matrix operations simultaneously by distributing work across many processing units.

In at least one embodiment, the system 100 can include a compute unit 102 that serves as a streaming multiprocessor capable of executing multiple operations concurrently. The compute unit 102 can provide the system's parallel processing capabilities for matrix multiply-accumulate operations and statistical computations. The compute unit 102 may serve as an independent processing entity capable of executing multiple thread groups concurrently and may provide the system's parallel processing capabilities. The compute unit 102 may be configured to execute thread blocks as warps of parallel threads, where each thread block consists of at least one warp, and in some embodiments, each warp may comprise 32 threads executing in a Single-Instruction, Multiple-Thread (SIMT) architecture.

The compute unit 102 can include an instruction cache 104 that contains instructions to be executed by the compute unit 102. A dispatch unit 106 can convert statistical reduction instructions into control signals for execution units. The dispatch unit 106 may decode instructions and distribute them to appropriate execution units, managing instruction flow and ensuring proper execution sequencing. Thread schedulers 108 can coordinate the execution of thread groups on the compute unit 102 and determine which operations execute at any given time while managing resource allocation.

The compute unit 102 can include a register file 110 that provides temporary storage for operands connected to data paths of functional units within the processing elements. The register file 110 can store intermediate results and statistical operation parameters during computation. The register file 110 may provide a set of registers for the processing elements and may provide temporary storage for operands connected to data paths of functional units of the processing elements.

A tensor memory 112 can store matrix multiply-accumulate operation results that require statistical processing. The tensor memory 112 can provide intermediate storage between global memory operations and register file operations, enabling efficient data movement patterns for statistical computations. The tensor memory 112 may serve as a high-bandwidth intermediate storage layer that buffers computation results before transfer to register files.

The system 100 can include a data transport and statistical reduction circuit 138 for performing statistical operations during data movement. The data transport and statistical reduction circuit 138 can be positioned within (or integrated with) a data transport path 136 between tensor memory 112 and register file 110, which can enable concurrent data transfer and statistical computation without requiring separate processing cycles for each operation. In some embodiments, the data transport and statistical reduction circuit 138 may support multiple data layout configurations, such as a 32-bit data path with a 32-bit layout (.32dp32bit) for single column processing per thread, 16-bit data path configurations with 32-bit layouts for threads (e.g., threads 0-15 (.16dp32bit_t0_t15) and threads 16-31 (.16dp32bit_t16_31)), and packed data layouts for increased throughput. The data transport and statistical reduction circuit 138 may implement column-wise data movement patterns where data elements from tensor memory 112 addresses are transferred based on logical tensor memory address calculations that can account for row and column alignment requirements. In some embodiments, the data transport and statistical reduction circuit 138 may support multiple source configurations for receiving data elements. The data transport and statistical reduction circuit 138 may be configured to receive data elements directly from matrix multiply-accumulate arrays 116 within tensor cores 114 during final accumulation cycles of matrix operations, enabling statistical reduction operations to commence before data is written to tensor memory 112. This direct data path from computation units to statistical reduction circuitry can reduce overall processing latency by eliminating intermediate memory write and read operations. Alternatively, the data transport and statistical reduction circuit 138 may receive data elements from tensor memory 112 for statistical processing of previously computed and stored results.

The compute unit 102 can include matrix multiply-accumulate arrays 116 within tensor core(s) 114 that execute matrix operations on input matrix data. The tensor cores 114 may include multiple processing elements that can execute multiple thread groups in parallel, with each processing element capable of being pipelined and executing single-precision, double-precision, and mixed precision operations. In some embodiments, each streaming multi-processor (SM) may execute thread blocks as warps of parallel threads, where statistical reduction operations are performed per-data path across thread lanes. The statistical reduction circuit 206 may maintain separate statistical values for each thread lane, enabling concurrent processing of up to 32 data columns per warp execution. The tensor cores 114 may generate matrix multiply-accumulate results at rates that saturate conventional register file bandwidth, necessitating intermediate storage using the tensor memory 112 and concurrent statistical processing during data transport to register file 110.

The compute unit 102 can include FP/INT core(s) 118 that perform specialized mathematical operations and load/store unit(s) 120 that handle memory access operations between different memory levels. Special functional unit(s) 122 may perform functions such as attribute evaluation and reciprocal square root, and may include tree traversal units configured to traverse hierarchical tree data structures.

An interconnect network 124 can provide communication pathways between different components within the compute unit 102 and enables data transfer between processing elements and memory structures. The interconnect network 124 may be configured as a crossbar that can connect any of the functional units to any of the registers in the register file 110.

A shared memory 126 can provide fast access to frequently used data and serves as an intermediate storage level between the tensor memory 112 and higher-level memory structures. A tensor memory accelerator 128 can manage data movement between different memory levels and coordinate statistical processing operations.

The system 100 can include a texture cache 130 that provides fast access to frequently used data and serves as an intermediate storage level. A shared L2 cache 132 can provide device-wide cache storage accessible across multiple compute units within the GPU. Global memory 134 can provide the largest storage capacity in the memory hierarchy and stores tensor data that is loaded into the tensor memory 112.

The architecture can enable efficient statistical calculations during data transport by allowing the data transport and statistical reduction circuit 138 to perform statistical operations concurrently with data movement between the tensor memory 112 and register file 110, while maintaining optimal memory bandwidth utilization.

In some embodiments, the data transport and statistical reduction circuit 138 may support multiple destination targets for statistical results. The data transport and statistical reduction circuit 138 may be configured to write statistical results to register file 110 for subsequent arithmetic operations, write results back to tensor memory 112 for use in iterative computation workflows, or directly provide statistical results to downstream processing units such as activation function units within special functional unit(s) 122, additional matrix computation units, or specialized neural network processing cores. This destination flexibility eliminates intermediate storage requirements and reduces data movement overhead in complex computational pipelines.

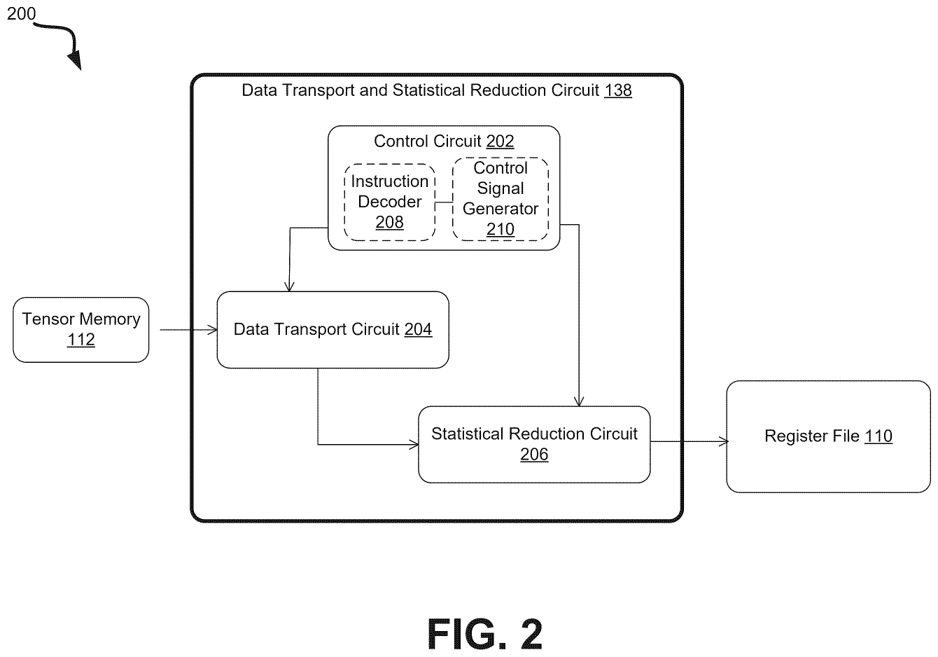

In some embodiments, the source and destination configurations for the data transport and statistical reduction circuit 138 may be determined through programmable control mechanisms, as described in further detail with reference to FIG. 2.

FIG. 2 is a block diagram showing detailed components 200 of the data transport and statistical reduction circuit 138 of the system 100 of FIG. 1, according to at least one embodiment. The diagram illustrates aspects of the data transport and statistical reduction circuit 138 that can enable statistical operations to occur concurrently with data movement operations.

The data transport and statistical reduction circuit 138 can include a control circuit 202 that manages the coordination of data movement and statistical operations. The control circuit 202 can include an instruction decoder 208 that processes single instructions for combined data transport and statistical operations. A control signal generator 210 can generate control signals that simultaneously activate data transport and statistical processing functions based on decoded instructions.

A data transport circuit 204 can handle the physical movement of data elements to register file 110. In some embodiments, the data transport circuit 204 may include a source selection circuit configured to receive data elements from multiple sources. The source selection circuit may select between receiving data elements from tensor memory 112 or directly from matrix multiply-accumulate arrays 116 within tensor cores 114 based on control signals from the control signal generator 210. When receiving data from tensor memory 112, the data transport circuit 204 can transfer previously stored computation results for statistical processing. When receiving data directly from matrix multiply-accumulate arrays 116, the data transport circuit 204 can capture data elements during final computation iterations, bypassing intermediate storage in tensor memory 112 for improved latency and reduced memory bandwidth utilization. The data transport circuit 204 can be configured to transfer data elements while providing those elements to statistical processing circuitry for concurrent analysis, maintaining data transfer rates while enabling statistical processing without additional memory access cycles.

In some embodiments, the data transport circuit 204 may include a destination selection circuit configured to route data and statistical results to multiple destinations. The destination selection circuit may direct transferred data elements to register file 110 for subsequent arithmetic operations, write statistical results back to tensor memory 112 for use in iterative computation workflows, or provide statistical results directly to downstream processing units such as activation function units within special functional unit(s) 122, additional matrix computation units, or specialized neural network processing cores. The destination selection may be controlled by signals from the control signal generator 210 based on instruction parameters decoded by the instruction decoder 208. This flexible source and destination routing architecture enables optimization of data flow paths based on specific computational workflow requirements, reducing unnecessary memory operations and improving overall processing efficiency.

A statistical reduction circuit 206 can perform statistical operations on data elements during their transfer through the data transport circuit 204, regardless of whether the data elements originate from tensor memory 112 or directly from matrix multiply-accumulate arrays 116. The statistical reduction circuit 206 can compute one or more running statistical values as each data element is processed, eliminating the need for separate statistical computation passes. The statistical reduction circuit 206 may support multiple types of statistical operations such as determination of a minimum value, a maximum value, a sum of values, and absolute value variants.

The control circuit 202 can coordinate the operation of the data transport circuit 204 and statistical reduction circuit 206 to ensure that data movement and statistical processing occur concurrently without interfering with each other. The instruction decoder 208 can process instruction encodings that specify data transport parameters, statistical operation types, and source/destination configurations within a single instruction format. In some embodiments, the instruction decoder 208 may process instructions (e.g., LDTM. STAT) with specific encoding formats, such as layout specifiers (e.g., .32dp32bit, .16dp32bit_t16_t31), numeric format identifiers (e.g., .U32, .S32, .F32), statistical operation types (e.g., .MAX, .MAXABS, .MIN, .MINABS, .SUM), data transfer quantities (e.g., .x32, .x4, .x8, .x16, .x32, .x64, .x128), and optional source/destination specifiers. The instruction decoder 208 may validate instruction parameters to ensure compatibility between selected layouts, numeric formats, statistical operations, and routing configurations before generating control signals.

In some embodiments, the source and destination configurations for the data transport and statistical reduction circuit 138 may be determined through programmable control mechanisms within the control circuit 202. The dispatch unit 106 may decode instruction fields that specify source selection (tensor memory 112 or direct from matrix multiply-accumulate arrays 116) and destination selection (register file 110, tensor memory 112, or downstream processing units) based on instruction parameters. The control circuit 202 may include configuration storage that stores source and destination routing parameters, enabling software to dynamically configure data flow paths based on computational requirements and workload characteristics. In some embodiments, the source and destination combinations may be predetermined for specific processing pipelines, while in other embodiments, the combinations may be fully configurable through instruction decode logic within the instruction decoder 208, enabling flexible adaptation to different neural network architectures and computation patterns. The control signal generator 210 may generate routing control signals that direct data elements from selected sources through the statistical reduction circuit 206 to selected destinations, memory address calculation signals for access patterns of the tensor memory 112 when used as a source, write enable signals for transported data and statistical results to selected destinations, and coordination signals for operation of the statistical reduction circuit 206.

The control signal generator 210 can produce timing signals that synchronize data transport operations with statistical processing operations, ensuring that statistical computations are performed on the correct data elements as they flow through the transport pathway regardless of the data source. In some embodiments, the control signal generator 210 may produce thread-specific control signals for warp-level execution where each warp includes multiple threads (e.g., 32 threads) executing in a Single-Instruction Multiple-Thread architecture. This coordination enables the system to achieve significant performance improvements by eliminating the need for separate data loading and statistical computation phases, and in some configurations, by eliminating intermediate memory storage operations when data flows directly from computation units to statistical processing circuits.

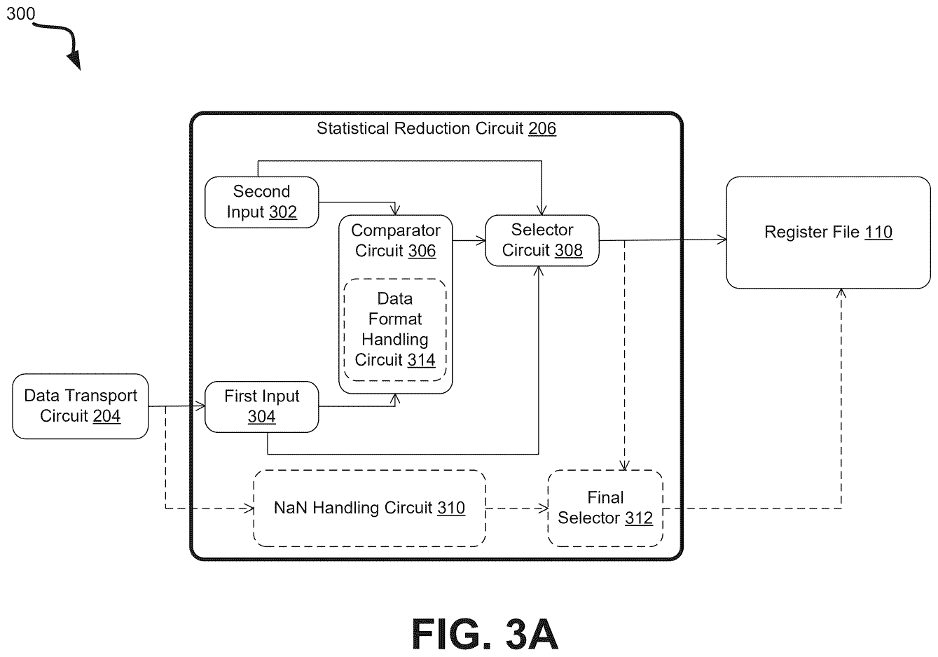

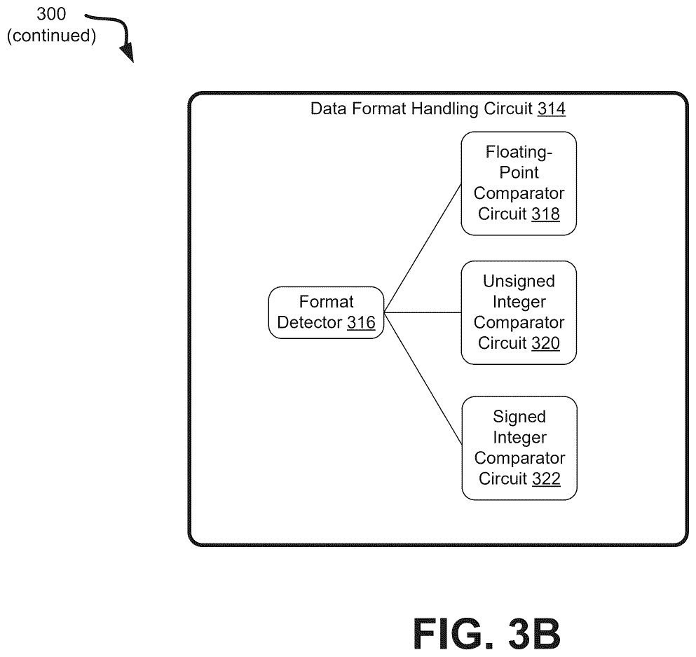

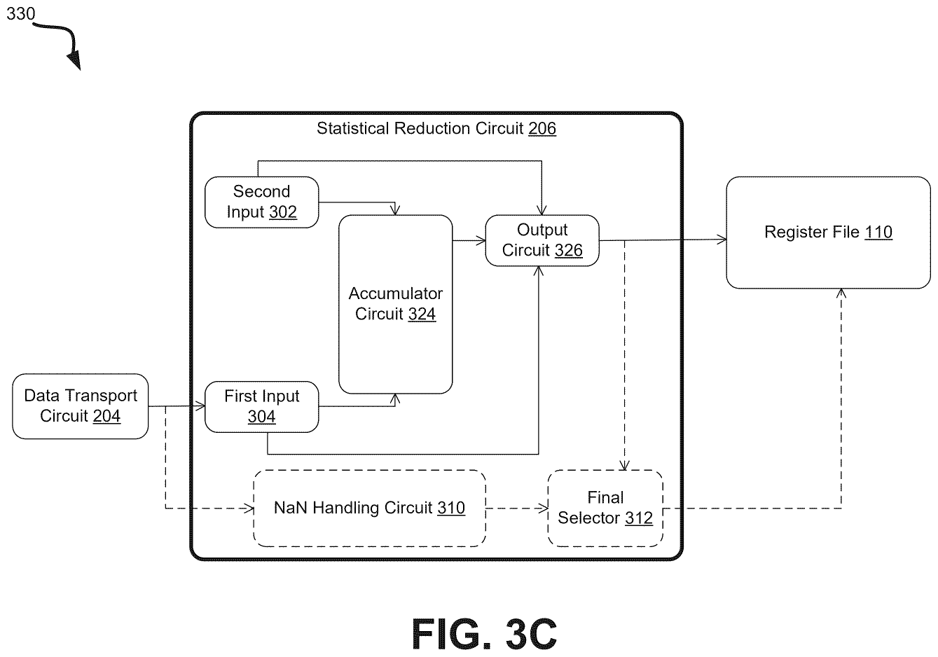

FIG. 3A illustrates example components 300 of the statistical reduction circuit 206 including specialized processing capabilities, according to at least one embodiment. The diagram shows an example architecture that can enable concurrent statistical processing during data transport operations.

The statistical reduction circuit 206 can include a first input 304 configured to receive current data elements from the data transport circuit 204. A second input 302 can receive previous statistical values from prior processing cycles, enabling the computation of one or more running statistical values across multiple data elements.

A comparator circuit 306 can compare the current data element with the previous statistical value to determine which value should be retained based on the selected statistical operation. The comparator circuit 306 may support multiple comparison types including greater-than, less-than, and absolute value comparisons depending on the statistical operation being performed.

A selector circuit 308 can output an updated statistical value based on the comparison results from the comparator circuit 306. The selector circuit 308 may choose between the current data element and the previous statistical value to maintain the desired statistical result as data flows through the circuit.

A NaN handling circuit 310 can detect and process not-a-number values in the data stream according to specified filtering modes. The NaN handling circuit 310 may implement specialized logic for handling not-a-number values in wide reduction operations where individual element inspection is not practical.

A final selector 312 can apply the results of NaN processing to determine the final statistical output. The final selector 312 may coordinate the outputs of the statistical processing pathway and NaN handling pathway to produce correct results according to the selected processing mode.

A data format handling circuit 314 can process data elements in multiple numeric formats including floating-point format, unsigned integer format, and signed integer format. The data format handling circuit 314 may include format detection and conversion capabilities to ensure that statistical operations are performed correctly regardless of the input data format.

The statistical reduction circuit 206 can operate continuously as data flows through the data transport circuit 204, updating statistical values with each new data element and maintaining running results that are available immediately upon completion of the data transport operation.

FIG. 3B illustrates an example data format handling circuit 314 for supporting multiple numeric data formats, according to at least one embodiment. The circuit demonstrates the capability to process different data types within the same statistical reduction framework.

A format detector 316 can identify the numeric format of incoming data elements and direct them to appropriate processing pathways. The format detector 316 may analyze data element encoding to determine whether the data represents floating-point values, unsigned integers, or signed integers.

A floating-point comparator circuit 318 can perform comparisons for floating-point format data elements, including proper handling of special floating-point values such as infinity and not-a-number values. The floating-point comparator circuit 318 may implement IEEE 754 floating-point comparison semantics to ensure correct statistical results.

An unsigned integer comparator circuit 320 can perform comparisons for unsigned integer format data elements, ensuring that statistical operations account for the full range of unsigned integer values. A signed integer comparator circuit 322 can perform comparisons for signed integer format data elements, properly handling both positive and negative values in statistical computations.

The data format handling circuit 314 can enable the statistical reduction circuit 206 to operate on mixed-precision data where different data elements may use different numeric formats, providing flexibility for diverse computational workloads while maintaining statistical accuracy across all supported formats.

FIG. 3C illustrates an alternative embodiment 330 of the statistical reduction circuit 206 that includes a processing path for accumulation operations, according to at least one embodiment. In this embodiment, the statistical reduction circuit 206 includes an accumulator circuit 324 configured to perform sum operations by accumulating current data elements with previous statistical values. The accumulator circuit 324 may operate in parallel with the comparator circuit 306 described above in reference to FIGS. 3A and 3B.

The accumulator circuit 324 may include addition logic configured to sum data elements in multiple numeric formats including floating-point format, unsigned integer format, and signed integer format. The accumulator circuit 324 can receive the current data element from the first input 304 and the previous statistical value (running sum) from the second input 302, perform the addition operation, and provide the updated sum to an output circuit 326.

The output circuit 326 can output an updated statistical results based on the accumulation results from the accumulator circuit 324. The output circuit 326 may function analogously to the selector circuit 308 of FIG. 3A, but for sum operations rather than comparison-based operations.

In some embodiments, the statistical reduction circuit 206 may route data elements and previous statistical values to appropriate processing circuits based on the statistical operation type specified in the decoded instruction. For comparison-based operations such as maximum, minimum, or absolute value operations, the statistical reduction circuit 206 may route data through the comparator circuit 306. For sum operations, the statistical reduction circuit 206 may route data to the accumulator circuit 324, which adds the current data element to the running sum value. This parallel architecture enables efficient processing of both comparison-based and accumulation-based statistical operations within a single statistical reduction circuit 206. For sum operations with NaN filtering, the final selector 312 may output the accumulated result from the accumulator circuit 324 or output circuit 326 directly.

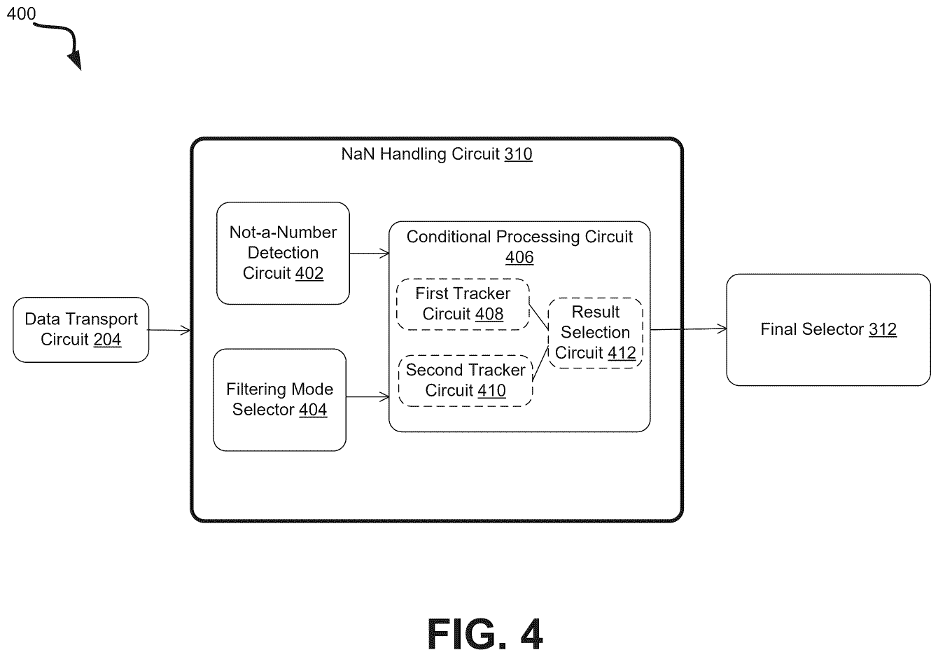

FIG. 4 illustrates example components 400 of the NaN handling circuit 310 for specialized floating-point processing, according to at least one embodiment. The circuit demonstrates advanced capabilities for managing not-a-number values in statistical computations.

A not-a-number detection circuit 402 can identify not-a-number values in the incoming data stream and trigger appropriate processing pathways. The detection circuit 402 may analyze floating-point encoding to distinguish not-a-number values from normal numeric values and infinity values.

A filtering mode selector 404 can select between different not-a-number handling modes based on the desired behavior for the statistical operation. The filtering mode selector 404 may choose between NaN filtering mode and non-filtering mode depending on the requirements of the specific application.

A conditional processing circuit 406 can implement the selected filtering behavior for not-a-number values. The conditional processing circuit 406 may include a first tracker circuit 408 configured to track whether any non-not-a-number (non-NaN) values have been encountered during the statistical operation. A second tracker circuit 410 can track whether any NaN values have been encountered during processing.

A result selection circuit 412 can output the final statistical result based on states of the first tracker circuit 408 and second tracker circuit 410. The states indicate whether non-NaN values and NaN values have been encountered during the statistical operation. In the first filtering mode, the result selection circuit 412 may exclude not-a-number values from the statistical reduction operation unless all data elements are not-a-number values. In the second filtering mode, the result selection circuit 412 may output a not-a-number result if any data element is a not-a-number value.

The NaN handling circuit 310 can provide consistent and predictable behavior for statistical operations on data that may contain not-a-number values, enabling proper handling of scenarios such as out-of-bounds padding in tensor operations where not-a-number values may be used to represent invalid or missing data.

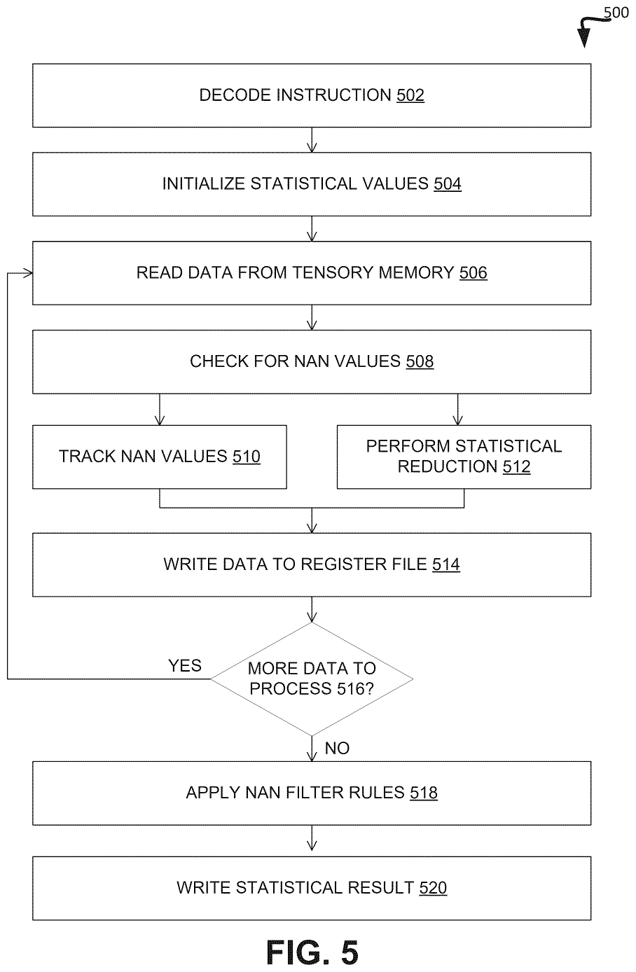

FIG. 5 illustrates a flow diagram of an example method 500 for performing statistical calculations during data transport, according to at least one embodiment. In at least one embodiment, the method 500 is performed by components of the data transport and statistical reduction circuit 138 of FIG. 2. In some embodiments, blocks depicted in FIG. 5 could be performed simultaneously or in a different order than depicted. Various embodiments can include additional blocks not depicted in FIG. 5 or a subset of blocks depicted in FIG. 5. The example demonstrates an operational sequence that can enable concurrent data movement and statistical processing.

At block 502, the instruction decoder 208 can decode an instruction that specifies both data transport parameters and statistical operation requirements. The instruction decoding may include extracting information such as a source location in tensor memory 112, a destination location in register file 110, the number of data elements to process, and the type of statistical operation to perform.

At block 504, the statistical reduction circuit 206 can initialize statistical values based on the type of statistical operation specified in the instruction. For minimum operations, the initial statistical values may be set to possible maximum values while, for maximum operations, the initial values may be set to possible minimum values. The initialization can ensure that the first data element processed will properly update the statistical result.

At block 506, the data transport circuit 204 can read data from tensor memory 112 while the statistical reduction circuit 206 simultaneously begins statistical processing. Data transport and statistical computation may occur in the same processing cycle rather than as separate sequential operations.

At block 508, in some embodiments, the NaN handling circuit 310 may check for NaN values in the data elements and implement appropriate handling based on the selected filtering mode. The NaN value detection may occur in parallel with other processing to avoid adding latency to the data transport operation.

At block 510, in some embodiments, the conditional processing circuit 406 may track NaN values according to the selected filtering mode. This tracking may include maintaining counters or flags by the first tracker circuit 408 and second tracker circuit 410 that indicate whether any NaN values or any non-NaN values have been encountered during the statistical operation.

At block 512, in some embodiments, processing circuits such as the comparator circuit 306 and selector circuit 308, and/or accumulator circuit 324 and output circuit 326, may perform statistical reduction operations on non-NaN data elements. The statistical processing may include comparing current data elements with one or more running statistical values for comparison-based operations, or accumulating current data elements within running sum values for sum operations, and updating the results based on the specified operation type.

At block 514, the data transport circuit 204 can write data to the register file 110 as part of the normal data transport operation. This write operation occurs concurrently with statistical processing and does not require additional cycles beyond those needed for data transport.

At block 516, the control circuit 202 can determine whether more data requires processing. If additional data elements remain, the process can return to block 506 to continue concurrent data transport and statistical processing. This loop continues until all specified data elements have been processed.

At block 518, in some embodiments, the result selection circuit 412 may apply NaN filter rules to determine the final statistical result based on the tracking information collected during processing. The filter rules may specify different behaviors depending on whether NaN values were encountered and the selected filtering mode.

At block 520, the statistical reduction circuit 206 can write the statistical result to the register file 110, completing the combined data transport and statistical operation. The statistical result becomes immediately available for subsequent operations without requiring additional processing cycles.

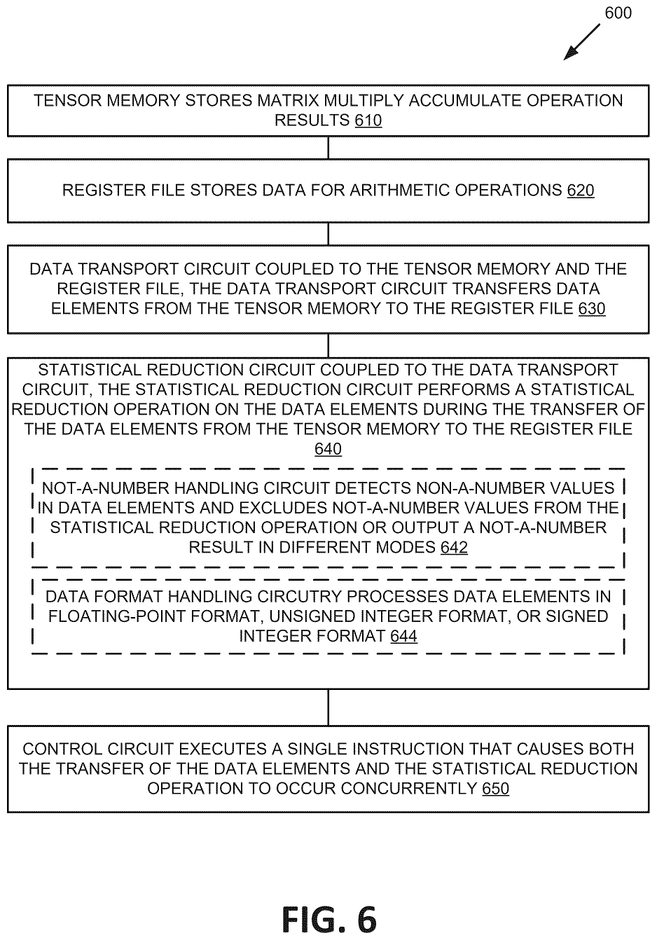

FIG. 6 illustrates a flow diagram of an example process 600 for concurrent data movement and statistical processing, according to at least one embodiment. In at least one embodiment, the process 600 is performed by components of the system 100 of FIG. 1 and/or data transport and statistical reduction circuit 138 of FIG. 2. In some embodiments, blocks depicted in FIG. 6 could be performed simultaneously or in a different order than depicted. Various embodiments can include additional blocks not depicted in FIG. 6 or a subset of blocks depicted in FIG. 6.

At block 610, tensor memory 112 stores matrix multiply-accumulate operation results that require statistical processing. In some embodiments, the tensor memory 112 may serve as high-bandwidth intermediate storage layer that buffers computational results from matrix multiply-accumulate arrays 116 before transfer to register file 110 for further processing. The tensor memory 112 may store results in multiple layout formats like 32-bit data path layouts and 160-bit data path layouts with 32-bit data organization.

At block 620, register file 110 stores data for arithmetic operations and provides the destination for both transported data elements and computed statistical results. In some embodiments, the register file 110 may provide temporary storage for operands that will be used in subsequent computational operations. The register file 110 may have fixed write bandwidth that becomes fully saturated during data transport operations from tensor memory 112. The statistical reduction circuit 206 may perform the statistical reduction operation without requiring additional writes to the register file 110 beyond storing the transferred data elements and a final statistical result.

At block 630, data transport circuit 204 coupled to the tensor memory 112 and the register file 110 transfers data elements from the tensor memory 112 to the register file 110. In some embodiments, the data transport circuit 204 may maintain optimal bandwidth utilization while enabling concurrent statistical processing without additional memory access overhead. In some embodiments, the data transport circuit 204 may transfer multiple columns of data elements per cycle in a series of transfer cycles, including two columns of data elements per transfer cycle.

At block 640, statistical reduction circuit 206 coupled to the data transport circuit 204 performs a statistical reduction operation on the data elements during the transfer of the data elements from the tensor memory 112 to the register file 110. In some embodiments, the statistical reduction circuit 206 may compute one or more running statistical values as data flows through the transport pathway, eliminating the need for separate statistical computation passes. The statistical reduction circuit 206 may include comparator circuit 306 to compare current data elements with previous statistical values, and selector circuit 308 to output updated statistical values based on comparison results. The statistical reduction operation may include, for example determination of maximum value, minimum value, maximum absolute value, or minimum absolute value. In some embodiments, the data transport circuit 204 may transfer a plurality of columns of data elements per cycle in a series of transfer cycles, and the statistical reduction circuit 206 may compute the statistical reduction operation across the plurality of columns during the series of transfer cycles. In some embodiments, the data transport circuit 204 may transfer two columns of the plurality of columns of the data elements per transfer cycle, and the statistical reduction circuit 206 may update the statistical reduction operation with values from both columns in each transfer cycle.

At block 642, not-a-number handling circuit 310 detects NaN values in data elements and excludes NaN values from the statistical reduction operation or outputs a NaN result in different modes. In some embodiments, the not-a-number handling circuit 310 may implement specialized filtering modes. In the first filtering mode, the conditional processing circuit 406 excludes NaN values from the statistical reduction operation unless all data elements are NaN values. In the second filtering mode, the conditional processing circuit 406 outputs a NaN result if any data element is a NaN value. The not-a-number handling circuit 310 may include first tracker circuit 408 to detect whether any non-NaN values have been encountered and second tracker circuit 410 to detect whether any NaN values have been encountered.

At block 644, data format handling circuitry 314 processes data elements in floating-point format, unsigned integer format, or signed integer format. In some embodiments, the data format handling circuitry 314 may include format detector 316 to identify numeric format of data elements, floating-point comparator circuit 318 to perform comparisons for data elements in floating-point format, unsigned integer comparator circuit 320 to perform comparisons for data elements in unsigned integer format, and signed integer comparator circuit 322 to perform comparisons for data elements in signed integer format. The data format handling circuit 314 can enable statistical operations on mixed-precision data while maintaining accuracy across different numeric representations.

At block 650, control circuit 202 executes a single instruction that causes both the transfer of the data elements and the statistical reduction operation to occur concurrently. The control circuit 202 may coordinate timing and control signals to ensure proper synchronization between data transport and statistical processing operations. In some embodiments, the control circuit 202 may include instruction decoder 208 to decode the single instruction and control signal generator 210 to generate control signals that simultaneously activate the data transport circuit 204 and the statistical reduction circuit 206 based on the single instruction decoded by the instruction decoder 208. The single instruction may include a statistical operation specifier that determines which type of statistical reduction operation the statistical reduction circuit 206 performs. In some embodiments, the processing device may include streaming multiprocessors (e.g., a plurality of compute units 102), each streaming multiprocessor including a corresponding tensor memory 112, register file 110, data transport circuit 204, statistical reduction circuit 206, and control circuit 202. Each streaming multiprocessor can execute the single instruction independently.

This process can enable the system to achieve optimal performance by eliminating the traditional separation between data loading and statistical computation phases. As a result, it provides significant cycle count reductions and improved bandwidth utilization for tensor processing workloads.

Other variations are within the spirit of the present disclosure. Thus, while the disclosed techniques are susceptible to various modifications and alternative constructions, certain illustrated embodiments thereof are shown in drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

Use of terms “a” and “an” and “the” and similar referents in the context of describing disclosed embodiments (especially in the context of the following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. In at least one embodiment, use of the term “set” (e.g., “a set of items”) or “subset” unless otherwise noted or contradicted by context, is to be construed as a non-empty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with context as used in general to present that an item, term, etc., may be either A or B or C, or any non-empty subset of the set of A and B and C. For instance, in the illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs, or one or more applications) executing collectively on one or more processors, by hardware, or combinations thereof. In at least one embodiment, code is stored on a computer-readable storage medium, for example, in the form of a computer program including a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause the computer system to perform the operations described herein. In at least one embodiment, a set of non-transitory computer-readable storage media includes multiple non-transitory computer-readable storage media, and one or more of the individual non-transitory storage media of the multiple non-transitory computer-readable storage media lack all of the code while the multiple non-transitory computer-readable storage media collectively store all of the code. In at least one embodiment, executable instructions are executed such that different instructions are executed by different processors—for example, a non-transitory computer-readable storage medium stores instructions, and a main central processing unit (“CPU”) executes some of the instructions while a graphics processing unit (“GPU”) executes other instructions. In at least one embodiment, different components of a computer system have separate processors, and different processors execute different subsets of instructions.

Accordingly, in at least one embodiment, computer systems are configured to implement one or more services that singly or collectively perform operations of the processes described herein, and such computer systems are configured with applicable hardware and/or software that enable the performance of operations. Further, a computer system that implements at least one embodiment of the present disclosure is a single device and, in another embodiment, is a distributed computer system including multiple devices that operate differently such that the distributed computer system performs the operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout the specification, terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers, or other such information storage, transmission, or display devices.

In a similar manner, the term ‘“processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may include one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, the terms “system” and “method” are used herein interchangeably insofar as a system may embody one or more methods, and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from a providing entity to an acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of the described techniques, other architectures may be used to implement the described functionality and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in the appended claims is not necessarily limited to the specific features or acts described. Rather, the specific features and acts are disclosed as exemplary forms of implementing the claims.

What is claimed is:

1. A processing device comprising:
a tensor memory to store matrix multiply-accumulate operation results;
a register file to store data for arithmetic operations;
a data transport circuit coupled to at least one of the tensor memory or matrix multiply-accumulate arrays, and coupled to the register file, the data transport circuit to transfer data elements from at least one of the tensor memory or the matrix multiply-accumulate arrays to the register file;
a statistical reduction circuit coupled to the data transport circuit, the statistical reduction circuit to perform a statistical reduction operation on the data elements during the transfer of the data elements from the at least one of the tensor memory or the matrix multiply-accumulate arrays to the register file; and
a control circuit to execute a single instruction that causes both the transfer of the data elements and the statistical reduction operation to occur concurrently.

2. The processing device of claim 1, wherein the statistical reduction circuit is to compute a running statistical value as each data element is transferred from the tensor memory to the register file.

3. The processing device of claim 2, wherein the statistical reduction circuit comprises:
a first input to receive a current data element from the data transport circuit;
a second input to receive a previous statistical value;
a comparator circuit to compare the current data element with the previous statistical value; and
a selector circuit to output an updated statistical value based on comparison by the comparator circuit.

4. The processing device of claim 2, wherein the statistical reduction circuit comprises:
a first input to receive a current data element from the data transport circuit;
a second input to receive a previous statistical value;
an accumulator circuit to accumulate the current data element with the previous statistical value for sum operations; and
an output circuit to output an updated statistical value based on output from the accumulator circuit.

5. The processing device of claim 1, wherein the register file has a fixed write bandwidth that is fully saturated by the data transport circuit during the transfer of the data elements, and wherein the statistical reduction circuit is to perform the statistical reduction operation without requiring additional writes to the register file beyond storing the transferred data elements and a final statistical result.

6. The processing device of claim 5, wherein the statistical reduction circuit is to store the final statistical result in the register file using a single additional write operation.

7. The processing device of claim 1, wherein the statistical reduction circuit comprises:
a detection circuit to detect not-a-number values in the data elements;
a filtering mode selector to select between a first filtering mode and a second filtering mode; and
a conditional processing circuit to:
in the first filtering mode, exclude not-a-number values from the statistical reduction operation unless all data elements are not-a-number values; and
in the second filtering mode, output a not-a-number result if any data element is a not-a-number value.

8. The processing device of claim 7, wherein the conditional processing circuit comprises:
a first tracker circuit to detect whether any non-not-a-number values have been encountered;
a second tracker circuit to detect whether any not-a-number values have been encountered; and
a result selection circuit to output a final statistical result based on states of the first tracker circuit and the second tracker circuit.

9. The processing device of claim 1, wherein the data transport circuit is to transfer a plurality of columns of the data elements from the tensor memory in a series of transfer cycles, and wherein the statistical reduction circuit is to compute the statistical reduction operation across the plurality of columns during the series of transfer cycles.

10. The processing device of claim 9, wherein the data transport circuit is to transfer two columns of the plurality of columns of the data elements per transfer cycle, and wherein the statistical reduction circuit is to update the statistical reduction operation with values from both columns in each transfer cycle.

11. The processing device of claim 1, wherein the statistical reduction operation comprises determination of at least one of a maximum value, a minimum value, a maximum absolute value, a minimum absolute value, or a sum of values.

12. The processing device of claim 1, wherein the control circuit comprises:
an instruction decoder to decode the single instruction; and
a control signal generator to generate control signals that simultaneously activate the data transport circuit and the statistical reduction circuit based on the single instruction decoded by the instruction decoder.

13. The processing device of claim 12, wherein the single instruction includes a statistical operation specifier that determines which type of statistical reduction operation the statistical reduction circuit performs.

14. The processing device of claim 1, wherein the statistical reduction circuit comprises data format handling circuitry to process data elements in a floating-point format, an unsigned integer format, or a signed integer format.

15. The processing device of claim 14, wherein the data format handling circuitry comprises:
a format detector to identify a numeric format of the data elements;
a floating-point comparator circuit to perform comparisons for the data elements in a floating-point format;
an unsigned integer comparator circuit to perform comparisons for the data elements in an unsigned integer format; and
a signed integer comparator circuit to perform comparisons for the data elements in a signed integer format.

16. The processing device of claim 1, further comprising:
a plurality of streaming multiprocessors, each streaming multiprocessor including the tensor memory, the register file, the data transport circuit, the statistical reduction circuit, and the control circuit, wherein each streaming multiprocessor is to execute the single instruction independently.

17. The processing device of claim 1, wherein the data transport circuit is to receive the data elements directly from matrix multiply-accumulate arrays during final computation iterations, bypassing intermediate storage in the tensor memory.

18. The processing device of claim 1, wherein the statistical reduction circuit is to write statistical results to at least one of: (i) the register file, (ii) the tensor memory for subsequent operations, or (iii) downstream processing units.

19. A method comprising:
storing, in a tensor memory, matrix multiply-accumulate operation results;
storing, in a register file, data for arithmetic operations;
at a data transport circuit coupled to the register file, receiving data elements from at least one of the tensor memory or matrix multiply-accumulate arrays, and transferring the data elements to the register file;
at a statistical reduction circuit coupled to the data transport circuit, performing a statistical reduction operation on the data elements during the transfer of the data elements from the at least one of the tensor memory or the matrix multiply-accumulate arrays to the register file; and
at a control circuit, executing a single instruction that causes both the transfer of the data elements and the statistical reduction operation to occur concurrently.

20. The method of claim 19, wherein the statistical reduction circuit computes a running statistical value as each data element is transferred from the tensor memory to the register file.
